(19) United States
(12) Patent Application Publication
(10) Pub. No.: US 2010/0310715 A1
(43) Pub. Date: Dec. 9, 2010

(54) CONCENTRATED HOPPED WORT AND METHOD OF ITS PRODUCTION

(76) Inventors: Karel KOSAR, Brno (CZ); Josef SKACH, Cercany (CZ)

Correspondence Address: OSTROLENK FABER GERB & SOFFEN, 1180 AVENUE OF THE AMERICAS, NEW YORK, NY, 100368403, US

(21) Appl. No.: 12/582,125

(22) Filed: Oct. 20, 2009

(30) Foreign Application Priority Data
Jun. 3, 2009 (CZ) PV 2009-353

(51) Int. Cl. C12C 12/04; A23L 1/202

(52) U.S. Cl. 426/16; 426/64

(57) ABSTRACT

The invention relates to the concentrated hopped wort for production of the Czech beer, which contains 80 to 100% by weight of pale malt of the Pilsner type, out of which at least 80% by weight is formed of malt from varieties approved for the Czech beer in the Council Regulation ES No. 510/2006, published in the Official Bulletin of the European Union 2008/C 16/05, while the extract in the solids of malt is at minimum 80% by weight, Kolbach Number is 36 to 42%, diastatic power is at minimum 220 units of W.-K., apparent final attenuation is at maximum 82% and friability is at minimum 75%, and it further contains 0 to 20% by weight of maltose and/or glucose syrup, hopping amounts from 6 to 14 g of α-bitter acids of hops to 100 I of wort, while up to 80% by weight of α-bitter acids of hops may come from the hop extract and at least 20% by weight of α-bitter acids of hops come from the dried or granulated hops, while out of total quantity of hops, granulated hops or hop extract from 15 to 30% by weight is formed of varieties of the Czech hops from \check{Z}atec, Tr\check{s}ice or Ú\check{s}t\check{e}k regions, and the solids content amounts to 40 up to 98% by weight.

### TECHNICAL FIELD

The invention relates to the concentrated hopped wort and concentrated hopped wort for production of the Czech beer. Next to this, the invention relates to the method for production of concentrated hopped wort and concentrated hopped wort for production of the Czech beer.

### BACKGROUND ART

The Bulletin of the European Union dated 23.1.2008 published the designation of origin for foodstuff “Czech beer” in the following specification.

Distinguishability of the Czech beer is based on many factors, first of all these are the raw materials used, know-how of brewery being developed for ages and the special brewing procedures. Production of the Czech beer is remarkable thanks to application of the decoction method of mashing process, boiling the wort and separate fermentation and beer ageing. Complete production method (carefully selected raw materials, malting and preparation of beer in a traditional region of the Czech Republic) gives rise to the specific and unique product of a high reputation. Technical parameters for the Czech beer are specified in the Official Bulletin of the European Union 2008/C 16/05 in the Council Regulation (ES) No. 510/2006. The beer could be distinguished thanks to the fact that malt and hops are prevailing, a weak flavour of pasteurisation, of yeast or esters is acceptable, foreign aromas or flavouring are not acceptable. Lower intensity of overall aroma of the Czech beer is caused by a relatively low content of undesired by-products of fermentation. The beer features a medium to strong tang with slow releasing of carbon oxide. Similarly, the richness is medium up to high, especially thanks to the content of non-fermented residuals of extract, characterised by the difference between the apparent and apparent final attenuation. Lower degree of attenuation means also a lower content of alcohol. Very important feature of the Czech beer is its bitterness. Bitterness degree of beer is medium up to higher, with a moderate to slight harshness which dies away for a longer time. Bitterness remains for a longer time in mouth, thus acts longer to the taste buds. Higher degree of bitterness supports the digestion process as well. Also for the Czech beer is characteristic higher concentration of polyphenols and higher value of pH. Pale beer (pale lager, pale draught beer and table beer) features a slight to medium aroma of pale malt and hops. The beer is of golden colour of medium to higher intensity. The beer is sparkling and after pouring into the glass it creates a compact white foam head.

Dark beer (dark lager and dark draught beer) features a distinct aroma of caramel and colourful malt. It features a medium tang with characteristic strong richness caused by a substantial difference between the apparent and apparent final attenuation and presence of non-fermentable substances in raw materials from which the beer is brewed. Bitterness character is influenced by a high beer's richness. As secondary flavours and aromas the toffee and sweetish are acceptable. At present there is an increasing interest in concentrates of hopped wort suitable for production of the Czech beer.

Concentrates of hopped wort are at present produced in various methods, for example through dialysis, membrane filtration, freezing out or evaporation.

The known wort concentrates are of an empty flavour, of low bitterness and of untypical flavour, by which the beverage made of these concentrates differs with its flavour from the Czech beer. The durability of the known wort concentrates is also problematic.

The UV 7163 in patent claim describes the hopped wort in a powder form made of malt of the Czech type, which has a composition of 5 to 100% by weight of pale malt of the Czech type, 5 to 95% by weight of malt of the Bavarian type, 5 to 95% by weight of caramel type, 0.1 to 50% by weight of colouring malt and 1 to 90% by weight of refined or raw sugar, hopping of 50 to 700 g of hops or recalculated quantity of hop extract to 100 I of wort, while the refractometric solids represent 90 to 99.9% by weight. The subject of technical solution thus represents the composition of hopped wort for dark beers. The described composition of hopped wort is quite unreasonable, because none of the upper limits of individual components cannot be reached, except for the colouring malt, for which in the claim the upper limit is stated to be 50%. The hopped wort according to the claim UV 7163 must always contain all components, while the minimum quantity is 5% by weight of pale malt of the Czech type, 5% by weight of malt of the Bavarian type, 5% by weight of malt of caramel type, 0.1% by weight of colouring malt and 1% by weight of refined or raw sugar. Thus upon observance of other components, the hopped wort according to the UV 7163 may contain at maximum 88.9% by weight of the pale malt of the Czech type or 88.9% by weight of malt of the Bavarian type or 88.9% by weight of caramel type or 84.9% by weight of refined or raw sugar.

In description of the UV 7163 in example 1 there is described the composition of hopped wort in a powder form for the pale beer containing 86% by weight of pale malt of the Czech type, 15% by weight of refined sugar, while next to this it contains 350 g of granulated hops to 100 I of wort and the refractometric solids amount to 96% by weight. Eeither this composition cannot be kept during production as the sum of components amounts to 101%.

The basic disadvantage of the hopped wort in a powder form described in the UV 7163 is nevertheless the fact that it contains refined or raw sugar, this is sucrose, which negatively influences the following main fermentation of beer and its sensorial quality during production of beer from the wort according to the UV 7163. That is, sucrose has been fermented at first and so the growth and activity of yeast is changed. Sensorial properties of beer are changed, especially the features being typical for the Czech beer are worsened, richness and foam head formation of the beer is lower. Composition of flavour and aromatic components of the beer which are formed by the yeast at fermentation is also changed.

The goal of the invention is to produce hopped wort in concentrated form which would be suitable for production of the Czech beer, and to propose method of production of such hopped wort.

### PRINCIPLE OF THE INVENTION

The goal of the invention has been achieved by the concentrated hopped wort for production of the Czech beer according to the invention whose principle consists in that it contains 80 to 100% by weight of pale malt of the Pilsner type, out of which at least 80% by weight is formed of malt from varieties approved for the Czech beer in the Council Regulation ES No. 510/2006, published in the Official Bulletin of the European Union 2008/C 16/05, while the extract in the solids of malt is at minimum 80% by weight, Kolbach Number is 36 to 42%, diastatic power is at minimum 220 units of W.-K., apparent final attenuation is at maximum 82% and friability is at minimum 75%, and it further contains 0 to 20% by weight of maltose and/or glucose syrup, hopping amounts from 6 to 14 g of α-bitter acids of hops to 100 I of wort, while up to 80% by weight of α-bitter acids of hops may come from the hop extract and at least 20% by weight of α-bitter acids of hops come from the dried or granulated hops, while out of total quantity of hops, granulated hops or hop extract from 15 to 30% by weight is formed of varieties of the Czech hops from \check{Z}atec, Tr\check{s}ice or Ú\check{s}t\check{e}k regions and the solids content amounts to 40 up to 98% by weight.

Such concentrated hopped wort is intended for brewing of beer, which upon observance of the recommended production procedure, by its parameters corresponds to the Czech beer, and in the case the concentrated wort is produced in the territory defined for the Czech beer, it shall be entitled to use the designation of origin as the Czech beer.

The goal of invention can be approached by concentrated hopped wort, which contains 80 to 100% by weight of pale malt of the Pilsner type, and next to it contains 0 to 20% by weight of maltose and/or glucose syrup, hopping amounts from 6 to 14 g of α-bitter acids of hops to 100 I of wort and content of solids amounts from 40 to 98% by weight.

The beer produced from such wort with its parameters will not correspond to the Czech beer, nevertheless it will be of a high quality.

For production of dark beers it is advantage, if the concentrated hopped wort further contains 0 to 20% by weight of malt of the Bavarian type, 0 to 20% by weight of malt of caramel type, 0 to 5% by weight of colouring malt.

For transportation it is advantage if the concentrated hopped wort is in a powder form when content of solids in it amounts 96 to 98% by weight.

The goal of the invention has been achieved by production method of concentrated hopped wort for production of the Czech beer, while the principle of the invention consists in that from 80 to 100% by weight of malt grist of pale malt of the Pilsner type out of which at least 80% by weight is formed of a malt from varieties approved for the Czech beer in the Council Regulation ES No. 510/2006, published in the Official Bulletin of the European Union 2008/C 16/05, while extract in malt solids is at minimum 80% by weight, Kolbach Number is 36 to 42%, diastatic power is at minimum 220 units of W.-K., apparent final attenuation is at maximum 82% and friability is at minimum 75%, is mixed with water and with 0 to 20% by weight of maltose and/or glucose syrup, 0 to 20% by weight of malt of the Bavarian type, 0 to 20% by weight of malt of caramel type, 0 to 5% by weight of colouring malt, and is subject to mashing by decoction procedure, after which the produced fresh mash is subject to hopping with 6 to 14 g of α-bitter acids of hops to 100 I of wort, while up to 80% by weight of α-bitter acids of hops may come from the hop extract and at least 20% by weight of α-bitter acids of hops come from dried or granulated hops, while out of total quantity of hops, granulated hops or hop extract, 15 to 30% by weight of the batch are the Czech hops varieties from \check{Z}atec, Tr\check{s}ice or Ú\check{s}t\check{e}k regions, while the maximum time for hop boiling is 60 to 90 minutes at total evaporating of at least six percent of volume, after then the wort is in situ thickened to 40 up to 80% by weight of solids.

By this method produced concentrated hopped wort is intended for brewing of beer, which upon observance of the recommended production procedure by its parameters corresponds to the Czech beer, and in case the concentrated wort is produced in the territory defined for the Czech beer, it shall be entitled to use the designation of origin as the Czech beer.

The goal of the invention can be approached by production method for concentrated hopped wort, according to which 80 to 100% by weight of malt grist of pale malt of the Pilsner type is mixed with water and with 0 to 20% by weight of maltose and/or glucose syrup, 0 to 20% by weight of malt of the Bavarian type, 0 to 20% by weight of malt of caramel type, 0 to 5% by weight of colouring malt, and is subject to mashing by decoction procedure, after which the produced fresh mash is subject to hopping with 6 to 14 g of α-bitter acids of hops to 100 I of wort, while the maximum time for hop boiling is 60 to 90 minutes at total evaporating of at least six percent of volume, after then the wort is in situ thickened to 40 up to 80% by weight of solids.

The beer produced from such wort with its parameters will not correspond to the Czech beer, nevertheless it will be of a high quality.

For transportation it is advantage if the concentrated hopped wort is in a powder form, therefore the wort is further dried in situ to have the content of solids 96 to 98% by weight.

Further valuation of the invention can be reached by application of the concentrated hopped wort according to any of the claims 1 to 4 or by application of the concentrated hopped wort produced by method according to any of the claims 5 to 7 by adding into non-alcoholic drinks, by which enhancing in sorts of flavours of the whole assortment of non-alcoholic drinks is achieved, at the same time a simple production method of these beverages is maintained.

### EXAMPLES OF EMBODIMENT

The hopped wort according to the invention for pale or dark beer contains the pale malt of the Pilsner type, while at least 80% by weight of this malt is formed of malt from varieties approved for the Czech beer, e.g. Bojos, Malz or Tolar and grown in the territory of the Czech Republic at least at 50%. Characteristic values of the malt are as follows:

| | |
|---|---|
| extract in malt solids | at minimum 80% by weight |
| Kolbach Number | 36 to 42% |
| diastatic power at minimum 220 | |
| units of W. −K | |
| apparent final attenuation | at maximum 82% |
| friability | at minimum 75%. |

The hopped wort for dark beers further contains 0 to 20% by weight of malt of the Bavarian type, 0 to 20% by weight of malt of caramel type, 0 to 5% by weight of colouring malt.

Production of hopped wort runs in the brewhouse, in which the malt grist is mixed with water and is subject to mashing. Mashing runs in single-, double- or three-stage decoction procedure and the infusion mashing is absolutely excluded. As an optimum seems to be the double-mashing decoction procedure with possibility of mash in at 37° C. with consequent heating to cca 52° C. With respect to the required density of mash in and mashes, there is not added hot water. The speed for heating the mashes is optional within an interval 1.0 to 1.6° C./min. The speed of liquid in pipeline during re-pumping is lower or equals to 1.6 m/s. Mash in and mashes are re-pumped through the lower inlets, by which their aeration is minimised. After the mashing process is completed, draining of fresh mash in the drainage tun or filtration of the fresh mash in mash filter is performed, which advantageously reduces aeration of the fresh mash to minimum at simultaneous increase of its clarity.

The fresh mash is brought into the wort copper, in which the fresh mash is boiled with hops and is transformed into wort. Adding of hops, either the dried, granulated or hop extract, into the fresh mash and boiling of fresh mash with hops is called hop boiling. Hopping is done with 6 to 14 g of α-bitter acids of hops to 100 I of wort, while up to 80% by weight of α-bitter acids of hops may come from the hop extract and at least 20% by weight of α-bitter acids of hops come from dried or granulated hops. Out of total quantity of hops, granulated hops or hop extract, 15 to 30% by weight of the batch are the Czech hops varieties from \check{Z}atec, Tr\check{s}ice or Ú\check{s}t\check{e}k regions. Thermal loading of wort is minimised by usage of a low-pressure, pulse or dynamic hop boiling. Maximum difference in temperature of wort and steam is 25° C. Maximum time of hop boiling is 60 to 90 minutes at total evaporation of at least six percent of volume to the required resultant concentration of wort 18% by weight.

From the wort copper the wort is pumped into a swirling tun. At the same time it is important to minimise aeration of wort. This is achieved by pumping the wort by means of wort pump with frequency converter, by means of which the speed of liquid pumping is regulated, which is 10 m/s at maximum. Time of stay in swirling tun is 30 minutes at maximum. Aeration of wort must be limited to minimum, because the oxidative processes increase values of colour, reduce content of reducers (expressed by T 150 value) and unfavourably influence the value of wort as a substrate for fermentation. From the swirling tun the wort is pumped for next cooling on a plate cooler, from where it is further pumped into a reservoir from which it is transported for thickening and drying. For thickening the evaporator or membrane filter or the refrigerating device is used.

In vacuum evaporator the wort is thickened at the temperature 40 to 75° C. and pressure 0.1 to 40 kPa to contain 40 to 80% by weight of solids. In this status the concentrated wort can be stored into cans or other tanks and distributed.

The wort may be, using a known method, thickened to 40 up to 80% by weight of solids by means of dialysis, membrane filter or in a refrigerating device.

Nevertheless the most suitable for distribution is the wort in a powder form. This is achieved through following drying of concentrated wort from the evaporator, membrane filter or from refrigerating device, for example on a jet or spray dryer to 96 up to 98% by weight of solids, by which the hopped wort in powder form is produced, which after homogenisation is filled into special transport bags having weight of 1 to 25 kg that are hermetically sealed.

To each package a respective quantity of dried brewer's yeasts is enclosed for bottom fermentation, being suitable for production of the Czech beer and the below mentioned technological procedure pro production of the Czech beer from this powder wort, which is typical for usage of the powder wort instead of common raw materials and usage of classic Czech yeast strains preserved in collection of the VÚPS.

### Preparation of Wort:

The wort concentrate or the powder wort prepared according to the above mentioned procedure is under a continuous stirring dissolved in water having temperature 30 to 40° C. in a ratio necessary to secure the initial concentration of wort from 7 to 18% by weight. The wort prepared in this manner is cooled to a required starting temperature and is subject to aeration through bubbling by means of air or oxygen to concentration 6-10 mg/l O₂.

### Main Fermentation:

For main fermentation the classic Czech yeast strains from collection of the Research Institute of Brewing and Malting are being used, registered under the numbers: 2, 3, 6, 9, and 96.

The main fermentation is run either in opened fermentation tuns, or in CKT. Starting temperature depending on the type and volume of fermenter varies in the range from 6 to 10° C., the maximum temperature then being from 9 to 14° C.

The green beer is barrelled at difference of apparent and apparent final attenuation from 2 to 10%. Temperature for barrelling is within an interval from 0 to 7° C.

### Ageing of Beer:

Ageing of beer is run at the temperature of 0 to 4° C. at overpressure of 0.8 to 1 bar for a period of 14 days at minimum.

### Filtration and Bottling of Beer:

Before filling into transport packages the beer may be filtered using a suitable filter securing the resultant clarity up to 0.7 j.EBC. For a colloidal stabilisation adsorbents of nitrogen and polyphenol substances may be used according to the required durability of the beer.

Concentrated hopped wort according to the invention, either in powder or liquid form may be used also as an addition into non-alcoholic beverages at their production or directly for production of such beverages.

### Example 1

For preparation of the pale hopped wort in powder form for production of the Czech beer, the pale fresh mash through a three-stage mashing procedure is produced at adding the pale malt of the Pilsner type in total quantity of 90% by weight, while 80% by weight of this adding is malt from varieties approved for the Czech beer like Bojos, Tolar or Malz, and 10% by weight of total quantity is maltose syrup. The fresh mash is brought into hop boiling, where hopping runs with 12 g of α-bitter acids from hops to 100 I of wort, while at minimum 30% of the batch is formed of the Czech hops and 70% is formed of the recalculated batch of hop extract or other granulated hops. Boiling lasts 70 minutes with total evaporation of 7%. The produced wort after separation of sediments and cooling to 20° C. is thickened in vacuum evaporator, at the working mode: power of evaporator is 1.2 m³/hr, temperature 70° C. and underpressure 0.8 kPa.

The wort concentrate with 40% of refractometric solids is in the place (in situ) delivered into the jet dryer, when the delay time at the temperature 170° C. is 2 sec, temperature of the dried powder is 70° C. Power of the dryer is 200 kg/hr. The dried wort is subject to homogenisation and filled into transport packages.

The wort concentrate may also be filled into cans or other reservoirs and transported in a liquid status.

### Example 2

For preparation of concentrated hopped wort for dark beers for production of the Czech beer, the dark fresh mash through a double-stage mashing procedure is produced at adding the pale malt in the quantity of 80% by weight, 10% by weight of adding is formed of the Bavarian type malt, 5% by weight the malt of caramel type and 5% by weight of glucose syrup. The fresh mash is brought into hop boiling, where hopping runs with 10 g of α-bitter acids from hops to 100 I of wort, while at minimum 30% of the batch is formed of the Czech hops and 70% is formed of the recalculated batch of hop extract or other granulated hops. Boiling lasts 90 minutes with total evaporation of 7%. The produced wort after separation of hot sediments at the temperature 80° C. is thickened in vacuum evaporator at the working mode: power of evaporator is 1.2 m³/hr, temperature 60° C. and underpressure 0.9 kPa.

The wort concentrate with 40% of refractometric solids is in the place (in situ) delivered into the jet dryer, at max. delay time 3 sec at the temperature 180° C., temperature of the dried powder is 75° C. Power of the dryer is 200 kg/hr. The dried wort is subject to homogenisation and is filled into transport packages.

The wort concentrate may also be filled into cans or other reservoirs and transported in a liquid status.

### Example 3

For preparation of pale hopped wort in paste form, the pale fresh mash through a double-stage mashing procedure is produced at adding the pale malt of the Pilsner type in total quantity of 80% by weight, while 80% by weight of this adding is formed of malt from varieties approved for the Czech beer as Bojos, Tolar or Malz, and 20% by weight of total quantity is glucose syrup. The fresh mash is brought into hop boiling, where hopping runs with 6 g of α-bitter acids from hops to 100 I of wort, while at minimum 30% of the batch is formed of the Czech hops and 70% is formed of the recalculated batch of hop extract or other granulated hops. Boiling lasts 70 minutes with total evaporation of 7%. The produced wort after separation of sediments and cooling to 20° C. is thickened in vacuum evaporator to 79% of solids, at the working mode: power of evaporator is 1.2 m³/hr, temperature 70° C. and underpressure 0.8 kPa.

The produced wort concentrate with 79% of refractometric solids is being filled under warm conditions without adding preserves means into transport packages.

### INDUSTRIAL APPLICABILITY

The hopped wort in a powder or concentrated liquid form in composition suitable for production of the Czech beer, containing the malt and hops from varieties suitable for production of the Czech beer may be utilised for production of the Czech beer in households, mini-breweries or industrial breweries. Next to this, the hopped wort according to the invention may be added into the non-alcoholic drinks which enhances sorts of flavours of the whole assortment of non-alcoholic drinks, while a simple production method of these beverages is maintained.

1. Concentrated hopped wort for production of the Czech beer, wherein it contains 80 to 100% by weight of pale malt of the Pilsner type, out of which at least 80% by weight is formed of malt from varieties approved for the Czech beer in the Council Regulation ES No. 510/2006, published in the Official Bulletin of the European Union 2008/C 16/05, while the extract in the solids of malt is at minimum 80% by weight, Kolbach Number is 36 to 42%, diastatic power is at minimum 220 units of W.-K., apparent final attenuation is at maximum 82% and friability is at minimum 75%, and it further contains 0 to 20% by weight of maltose and/or glucose syrup, hopping amounts from 6 to 14 g of α-bitter acids of hops to 100 I of wort, while up to 80% by weight of α-bitter acids of hops may come from the hop extract and at least 20% by weight of α-bitter acids of hops come from the dried or granulated hops, while out of total quantity of hops, granulated hops or hop extract from 15 to 30% by weight is formed of varieties of the Czech hops from \check{Z}atec, Tr\check{s}ice or Ú\check{s}t\check{e}k regions and the solids content amounts to 40 up to 98% by weight.

2. Concentrated hopped wort, wherein it contains 80 to 100% by weight of pale malt of the Pilsner type, and next to it contains 0 to 20% by weight of maltose and/or glucose syrup, hopping amounts from 6 to 14 g of α-bitter acids of hops to 100 I of wort and content of solids amounts from 40 to 98% by weight.

3. Concentrated hopped wort according to the claim 1, wherein it further contains 0 to 20% by weight of malt of the Bavarian type, 0 to 20% by weight of malt of caramel type, 0 to 5% by weight of colouring malt.

4. Concentrated hopped wort according to claim 1, wherein the content of the solids amounts from 96 to 98% by weight.

5. Production method of concentrated hopped wort for production of the Czech beer, wherein from 80 to 100% by weight of malt grist of pale malt of the Pilsner type out of which at least 80% by weight is formed of a malt from varieties approved for the Czech beer in the Council Regulation ES No. 510/2006, published in the Official Bulletin of the European Union 2008/C 16/05, while extract in malt solids is at minimum 80% by weight, Kolbach Number is 36 to 42%, diastatic power is at minimum 220 units of W.-K., apparent final attenuation is at maximum 82% and friability is at minimum 75%, is mixed with water and with 0 to 20% by weight of maltose and/or glucose syrup, 0 to 20% by weight of malt of the Bavarian type, 0 to 20% by weight of malt of caramel type, 0 to 5% by weight of colouring malt, and is subject to mashing by decoction procedure, after which the produced fresh mash is subject to hopping with 6 to 14 g of α-bitter acids of hops to 100 I of wort, while up to 80% by weight of α-bitter acids of hops may come from the hop extract and at least 20% by weight of α-bitter acids of hops come from dried or granulated hops, while out of total quantity of hops, granulated hops or hop extract, 15 to 30% by weight of the batch are the Czech hops varieties from \check{Z}atec, Tr\check{s}ice or Ú\check{s}t\check{e}k regions, while the maximum time for hop boiling is 60 to 90 minutes at total evaporating of at least six percent of volume, after then the wort is in situ thickened to 40 up to 80% by weight of solids.

6. Production method of concentrated hopped wort, wherein 80 to 100% by weight of malt grist of pale malt of the Pilsner type is mixed with water and with 0 to 20% by weight of maltose and/or glucose syrup, 0 to 20% by weight of malt of the Bavarian type, 0 to 20% by weight of malt of caramel type, 0 to 5% by weight of colouring malt, and is subject to mashing by decoction procedure, after which the produced fresh mash is subject to hopping with 6 to 14 g of α-bitter acids of hops to 100 I of wort, while the maximum time for hop boiling is 60 to 90 minutes at total evaporating of at least six percent of volume, after then the wort is in situ thickened to 40 up to 80% by weight of solids.

7. Production method of concentrated hopped wort according to the claim 5, wherein the wort is further dried in situ to have the content of solids 96 to 98% by weight.

8. Application of the concentrated hopped wort according to claim 1, wherein in optional quantity it is being added into non-alcoholic beverages.

9. Application of the concentrated hopped wort produced through the method according to claim 5, wherein in optional quantity it is being added into non-alcoholic beverages.
